(19) United States
(12) Patent Application Publication
(10) Pub. No.: US 2026/0231903 A1
(43) Pub. Date: Aug. 13, 2026

(54) AN IDENTIFICATION TAG

(71) Applicant: ALLFLEX EUROPE SAS, Vitré (FR)

(72) Inventors: Jean-Noël Yves Roger MARY, Balazé (FR); Steven Jeremy Yoann RATTIER, Montjean (FR); Pierric BESNARD, Laval (FR); Rémi Gérard MONNET, Noyal Pontivy (FR); Yannick PIGER, Domalain (FR)

(73) Assignee: ALLFLEX EUROPE SAS, Rahway, NJ (US)

(21) Appl. No.: 19/153,393

(22) PCT Filed: Aug. 2, 2025
(86) PCT No.: PCT/EP2024/053132

§ 371 Date: Aug. 4, 2025

(30) Foreign Application Priority Data
Feb. 9, 2023 (EP) 23305170.5

(51) Int. Cl. A01K 11/00; B29C 65/08; B29L 7/00

(52) U.S. Cl. CPC A01K 11/001; B29C 65/08; B29L 2007/004

(57) ABSTRACT

The disclosure relates to a first part of an animal identification tag, having a first flat surface portion (11) comprising at least one raised portion (1121). According to the disclosure, said at least one raised portion (1121) has an elliptical ring shape which is configured to be melted to provisionally join the first flat surface portion to a second flat surface portion of a second part of an animal identification tag.

### 1. FIELD OF THE DISCLOSURE

The field of the disclosure relates to systems and methods for identification of animals and/or the removal of tissue samples from animals. For example, the disclosure relates to identification tags, and identification tags that can also be used to withdraw a sample of tissue from an animal.

More specifically, as described more fully herein, the disclosure relates to methods and systems for provisionally joining two parts of at least one identification tag, such that said parts are connected during transport and loading of one part on an applicator, and then separated for loading the other part or another tag on the applicator.

### 2. BACKGROUND

For many years, the identification of livestock, such as cattle, pigs or sheep, has become mandatory in many countries throughout the world, for example to ensure the sanitary monitoring of livestock or the origin of the meat offered to consumers.

Identification tags may be one-piece identification tags or two-piece identification tags, designed to be applied to an animal, for example to an ear of the animal. An identification tag typically comprises a male part and a female part. The male part comprises a stem ending in a tip that can be inserted into a cavity of the female part, through the animal's ear, to lock the tag to the animal's ear.

When two-piece identification tags are used, the same identification number is conventionally marked on both the male part and the female part of the identification tag, on a flat surface portion of each part.

It is also known to collect tissues from an animal, either when applying an identification tag to the animal using a tissue sampling tag, or using a tissue sampling unit. Tissue sampling can be carried out throughout the animal's existence and after death, for example to detect diseases and certify the animal's identity by comparison of DNA sequences or to assess its genetic value. Once collected, the sample of animal tissue can be stored and/or transmitted to a laboratory for analysis.

In addition, in some countries, two identification tags should be applied to a same animal, for example one to each ear. Such tags should carry the same identifier in order to identify the same animal. One of them could be a tissue sampling tag.

As a consequence, a user (for example a farmer) may have to handle two two-piece identification tags, that is two male parts and two female parts carrying the same identification number, to mark one animal.

To make the user's task easier, the different parts are conditioned or packed individually on a plastic tray, and ordered by identification number.

However, such plastic tray usually carries many identification tags, for example ten male parts and ten female parts, that can be used to identify five different animals if each animal carries two identification tags. Five different identification numbers can thus be used.

Due to the number of parts to be handled, there is a risk for the user to use a wrong male or female part, i.e. to apply a male part with a different identification number than a female part to one ear of the animal, or to apply two tags with different identification numbers to the two ears of the same animal. In addition, even without the risk of the wrong tag being applied in this manner, the task of applying tags is time consuming and difficult for the user.

There is therefore a need for a new solution that would improve and simplify the user's tasks.

### 3. SUMMARY

The disclosure relates to a first part of an animal identification tag, that has a first flat surface portion comprising at least one raised portion. Said at least one raised portion has an elliptical ring shape which is configured to be melted to provisionally join the first flat surface portion to a second flat surface portion of a second part of an animal identification tag.

For example, the first part is the female part of a two-piece animal identification tag, and the second part is the male part of a two-piece animal identification tag (the same identification tag or another one). In another example, the first part is the male part of a two-piece animal identification tag, and the second part is the female part of a two-piece animal identification tag. In yet another embodiment, the first part is a first male part and the second part is a second male part. In still another embodiment, the first part is a first female part and the second part is a second female part. In another example, the first part is a first one-piece identification tag, and the second part is a second one-piece identification tag.

The raised portion according to the disclosure has an elliptical ring shape. It can be noted that a circle is a particular case of an ellipse where the stretching factor is zero. In a specific embodiment, the elliptical ring shape can thus be a circular ring shape.

The elliptical ring shape has many advantages over other shapes. For example, before the first and second parts are joined, the first part can be handled without risk of injury, as a raised portion having an elliptical ring shape has no sharp edges. When the first and second parts are joined, the “line of contact” between the first and second parts is an elliptical ring or a circular ring, which can be continuous or discontinuous. There are thus many points of contact between the two parts, which ensure that both parts remain connected for example during transport from a manufacturing center to a farm. In addition, the first and second parts can be easily disjoined or separated by pulling apart on both parts, without any constraints on the pulling direction when a user needs to load the tag on an applicator, as the distance between any point of the elliptical ring and the center of the ellipse is approximately the same.

In other words, the user does not have to pull on a specific way to detach the two parts, which make the user's task easier. Moreover, once detached, the first flat surface and the second flat surface that were connected remain smooth, thus ensuring that the animal on which that tag is applied is not injured.

According to at least one embodiment, no external material (such as glue, tape or the like) has to be added between the first part and the second part to temporarily join them. When a first part is produced, an additional layer of the material used to form the first flat surface portion can be used to form the raised (or embossed) elliptical ring-shape portion(s). For example, the first flat surface portion is made of polyurethan, or polyamide, etc. The first part can therefore be easily produced, for instance by injection molding.

In a specific embodiment, said at least one raised portion has a discontinuous elliptical ring shape.

The edge of the raised portion(s) can thus form a dashed elliptical or circular ring, such as a discontinuous raised portion. In this way, less material is needed to make the raised portion(s) compared to a continuous, or not broken up, raised portion. In addition, the separation of both parts can be further facilitated because of the reduced surface area.

In a particular embodiment, said at least one raised portion has an inner diameter comprised between 3.5 mm and 4.5 mm, an outer diameter comprised between 4.5 mm and 5.5 mm, and a thickness between the inner and outer diameters comprised between 0.5 mm and 1.5 mm.

For example, the inner diameter of an elliptical ring-shape raised portion is 4 mm, the outer diameter is 5 mm, and the thickness is thus 1 mm. The thickness of the elliptical ring-shape raised portion can be constant from the base of the raised portion to the top/edge of the raised portion. In variant, the thickness of the elliptical ring-shape raised portion can slightly decrease from the base of the raised portion to the top/edge of the raised portion.

In a specific embodiment, said at least one raised portion has a height comprised between 0.2 mm and 0.6 mm.

The height of the raised portion can be measured from the first flat surface (base of the raised portion) to the edge of the raised portion. As such height is very small, there is no risk of injury for the user when manipulating the first part before the first and second parts are joined or for the user or the animal after the first and second parts have been disjoined.

The strength of the joint can be controlled by setting different size and/or height and/or material of the raised portion(s).

In a particular embodiment, the first flat surface portion comprises two raised portions having each an elliptical ring shape (which can be continuous or discontinuous).

In this way, it is possible to join at least three different parts to form a strip of parts. Such strip can be easily handled or packaged. If an identifier is printed on the parts before they are joined, the parts can be arranged in a selected order, to facilitate the task of the user when loading the parts on an applicator. For example, a male part comprises a first raised portion on a right area of its flat surface portion, and a second raised portion on a left area of its flat surface portion. A first female part can overlap the first raised portion and a second female part can overlap the second raised portion. In another embodiment, a first raised portion is provided on the top side of the flat surface portion, and a second raised portion is provided on the back side of the flat surface portion. In a first embodiment, called here “head to tail” or “top to tail”, the first flat surface portion comprises a top area connected to a first linking portion of the first part, and a bottom area. In this embodiment, said at least one raised portion is located in the bottom area of the first flat surface portion.

For example, the first and second parts are the two parts of a two-piece identification tag. The first linking portion can be configured to cooperate with a second linking portion of the second part of the two-piece animal identification tag to fix the tag on the animal.

In the first embodiment, the two parts can be placed top to tail, such that the bottom area of the first flat surface and the bottom area of the second flat surface partially overlap before joining the two parts. Such embodiment can be used for example to join only the two parts of a two-piece identification tag. In this way, one unit comprises one pair of temporarily linked male and female parts (i.e. one two-piece identification tag), that can carry the same identifier, or different identifiers that can be used to identify the same animal (for example an identification number and a corresponding data matrix). The risk of using a female part with a wrong male part (i.e. with an identifier that does not match) is thus limited. In addition, the handling of the identification tag and loading on an applicator can be facilitated.

In a second embodiment, called here “side overlapping”, the first flat surface portion comprises a left area and a right area both connected to a first linking portion of the first part. In this embodiment, said at least one raised portion is located in the left area and/or in the right area of the first flat surface portion.

For example, the first and second parts are the two parts of a two-piece identification tag. The first linking portion can be configured to cooperate with a second linking portion of the second part of the two-piece animal identification tag to fix the tag on the animal.

In the second embodiment, the two parts can be placed such that the right area of the second flat surface portion partly overlap the left area of the first flat surface portion. Such embodiment can be used for example to join two two-piece identification tags that can be used, for instance, to identify the same animal. In this case, the two female parts can be placed side by side, and the two male parts can be placed side by side, such that one of the female parts can be connected to both male parts and one of the male parts can be connected to both female parts.

In this way, one unit comprises two pairs of temporarily linked male and female parts, that can carry the same identifier, or different identifiers that can be used to identify the same animal (for example an identification number and a corresponding data matrix). Both pairs can be applied to the same animal, for example to mark its two ears. The risk of mismatch between the male and female parts and between the two identification tags can be reduced. In addition, the handling of the identification tags and loading on an applicator can be facilitated.

In the first or second embodiment, the first linking portion can be a stem ending in a tip and the second linking portion can be a cavity if the first part is a male part and the second part is a female part. If the first part is a female part and the second part is a male part, the first linking portion can be a cavity of the female part and the second linking portion can be a stem ending in a tip. It can be noted that the tip of the male part can be truncated, for example when the identification tag can also be used to withdraw a sample of tissue from the animal. In this way, a biopsy needle can project beyond the truncated tip, in order to collect a tissue sample. Such needle can indeed slide inside the male shaft to collect a tissue sample and then be removed out of the male part.

In a specific embodiment, an identifier is printed on a side of the first flat surface portion opposite to the side comprising said at least one raised portion.

In other words, the raised portion(s) can be formed on a side of the first flat surface, and an identifier of the animal (such as an identification number, a data matrix, an alpha digital code, a bar code, etc.) can be printed on the other side of the first flat surface. Such identifier can be printed on the back of the first flat surface before the first and second parts are joined, or after the first and second parts have been joined.

The disclosure also relates to a method for provisionally joining a first part and a second part of at least one animal identification tag, the first part having a first flat surface portion and the second part having a second flat surface portion, at least one of the first or second flat surface portions comprising at least one raised portion having an elliptical ring shape. Such method comprises:
placing the first part and the second part such that the first flat surface portion and the second flat surface portion partly overlap at the location of said at least one raised portion,
melting said at least one raised portion until said first and second parts are joined.

The disclosure therefore proposes a method to join temporarily at least two parts of at least one identification tag. For example, the parts are joined at the manufacturing center, before packaging.

To do so, the different parts are placed such that their first and second flat surface portion partly overlap at the location of the raised portion(s), and then welded by melting the raised portion(s). The different parts can be order be increasing or decreasing numbers, for instance.

For example, said melting is performed by ultrasonic welding.

Such solution can ensure a quick and accurate welding.

In the first embodiment (“head to tail”) described above, said placing places the first part and the second part such that the bottom area of the first flat surface portion partly overlaps the second flat surface portion (the first flat surface portion of the first part comprising a top area connected to a first linking portion of the first part, and a bottom area, the first linking portion being for example configured to cooperate with a second linking portion of the second part to fix the two-piece animal identification tag on the animal).

The advantages of such first embodiment have already been disclosed above.

In the second embodiment (“side overlapping”) described above, said placing places the first part and the second part such that the second flat surface portion partly overlaps the left area and/or the right area of the first flat surface portion (the first flat surface portion of the first part comprising a left area and a right area both connected to a first linking portion of the first part, the first linking portion being for example configured to cooperate with a second linking portion of the second part to fix the two-piece animal identification tag on the animal).

The advantages of such second embodiment have already been disclosed above.

In a specific embodiment, said placing places a first two-piece identification tag and a second two-piece identification tag, such that:
the left area of the first flat surface portion of the first identification tag overlaps the right area of the second flat surface portion of the first identification tag,
the right area of the first flat surface portion of the first identification tag overlaps the left area of the second flat surface portion of the second identification tag, and
the left area of the first flat surface portion of the second identification tag overlaps the right area of the second flat surface portion of the second identification tag.

Said identification tags carry for instance the same identifier, or different identifiers that can be used to identify the same animal. As already mentioned, the risk of mismatch between male and female parts and between identification tags can thus be reduced, as the four parts of the two identification tags that have to be apply to the animal are joined until the loading on the applicator.

The disclosure also relates to a method for loading an animal identification tag on an applicator, the animal identification tag comprising a first part having a first flat surface portion and a second part having a second flat surface portion, the first flat surface portion and the second flat surface portion partly overlapping, the first part and the second part being provisionally joined together. Such method comprises:
loading the second part of the animal identification tag on the applicator, with the first part and the second part joined together,
separating the first part and the second part by a movement of the applicator,
loading the first part of the animal identification tag on the applicator.

As already mentioned, the parts can be connected at the manufacturing center, before packaging. During transport (for example from the manufacturing center to a farm), the parts remain connected. The parts can be separated only when the user is ready to apply the tag.

More specifically, two parts can be disjoined only when one of said parts has been loaded on the applicator. In this way, only one hand is needed to pull apart the two parts, the other hand holding the applicator. The loading and separation of the two parts is thus facilitated, thus enhancing the experience of the user/farmer.

In addition, thanks to the elliptical ring-shape of the raised portion(s), the user can detach the two parts from every direction, i.e. does not have to pull the parts on a specific way. Indeed, the distance between any point of the elliptical ring and the center of the ellipse is approximately the same such that the force needed to separate the parts does not vary with the direction of the force.

In one particular embodiment, separating the first part and the second part comprises pulling the applicator and pulling the second part in opposite directions.

### 4. LIST OF FIGURES

Other features and advantages of the disclosure shall appear more clearly from the following description of particular embodiments, given by way of a simple illustratory and non-exhaustive examples and from the appended figures, of which:

FIGS. 1A and 1B are top views of a female part according to different embodiments,

FIG. 1C illustrates an example of the female parts of FIGS. 1A and 1B back side,

FIGS. 2A to 2D illustrate different examples of circular ring-shape raised portions,

FIG. 3 illustrates exemplary steps of a method for provisionally joining a first part and a second part according to an embodiment,

FIG. 4A shows two overlapping parts in a “head to tail” arrangement,

FIG. 4B shows two overlapping parts in a “side overlapping” arrangement,

FIG. 5 illustrates exemplary steps of a method for loading an animal identification tag on an applicator according to an embodiment,

FIGS. 6A to 6F illustrate the method for loading a male part and a female part which have been joined in a “head to tail” arrangement,

FIGS. 7A to 7E illustrate the method for loading a male part and a female part which have been joined in a “side overlapping” arrangement.

### 5. DETAILED DESCRIPTION OF EMBODIMENTS OF THE DISCLOSURE

The general principle of the disclosure relates on providing at least one raised portion on a first part of an animal identification tag, that can melt to temporary join the first part with at least second part of an animal identification tag (which can be the same identification tag if we consider two-piece identification tag, or another tag).

In the description below, several examples are provided where the first part is for example the female (resp. male) part of a two-piece identification tag, and the second part is the male (resp. female) part of the two-piece identification tag. However, those are only examples, and the method described below can be used to join male parts together and/or female parts together, that belong not to the same identification tag, or even one-piece identification tags. In the latter case, for example, the first part can be a first one-piece identification tag and the second part can be a second one-piece identification tag.

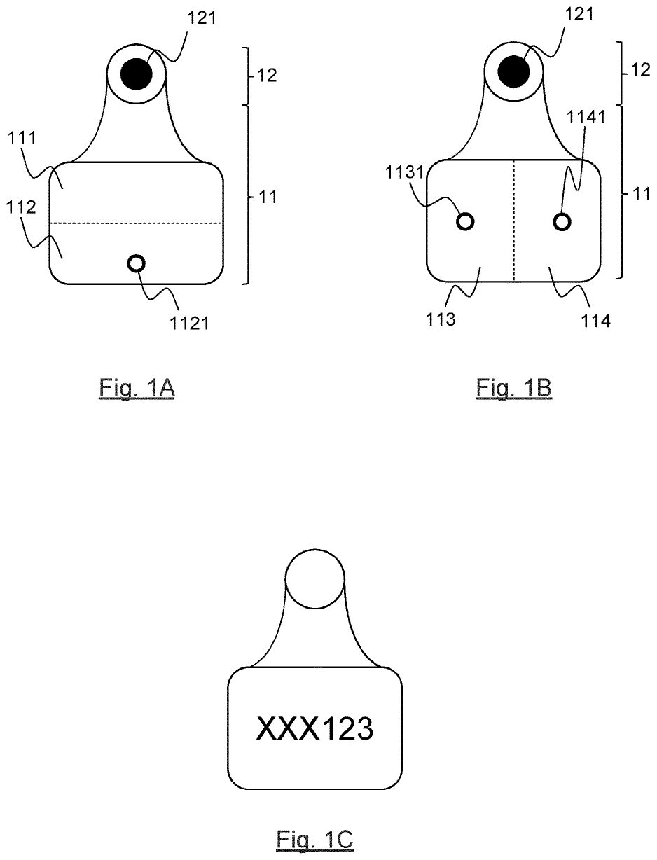

FIGS. 1A and 1B are top views of a female part according to different embodiments. The female part comprises a first flat surface portion 11 and a first linking portion 12. The first linking portion 12 comprises a cavity 121, in which the tip of the male part can be engaged to lock both parts of the tag. The shape and/or size of the first flat surface portion 11 and of the first linking portion 12 are not limited to the examples illustrated, and can vary, depending for example on the size of the animal on which the tag is going to be applied.

According to the disclosure, the first flat surface portion 11 comprises at least one elliptical ring-shape raised portion.

In the first embodiment illustrated in FIG. 1A, the first flat surface portion 11 comprises a top area 111, which is connected to the first linking portion 12, and a bottom area 112. For example, one raised portion 1121 having the shape of a circular ring (also called an annulus) is located in the bottom area 112. One or more raised portion(s) can be provided on the left part, the central part, or the right part of the bottom area 112. There may also be (in addition or alternatively) one or more raised portion(s) on the left part, the central part, or the right part of the top area 111.

In the second embodiment illustrated in FIG. 1B, the first flat surface portion 11 comprises a left area 113 and a right area 114, with both side areas being connected to the first linking portion 12. For example, a first circular ring-shape raised portion 1131 is located in the left area 113, and a second circular ring-shape raised portion 1141 is located in the right area 114. One or more raised portion(s) can be provided on the upper part, middle part, or bottom part of the left area 113. One or more raised portion(s) can be provided (in addition or alternatively) on the upper part, middle part, or bottom part of the right area 114.

The raised portion(s) 1121, 1131, 1141 can be molded at the same time as the first part, by using a dedicated mold. The same material can thus be used for the first flat surface and the raised portion. As an alternative, the raised portion can be fixed to the first part after the first part has been manufactured.

The material of the raised portion is for example polyurethan, or polyamid, etc.

FIG. 1C illustrates an example of the female parts of FIGS. 1A and 1B back side, i.e., the side opposite to the side comprising said at least one raised portion. As illustrated in FIG. 1C, an identifier, such as an identification number, a data matrix, an alpha digital code, a bar code, etc., can be printed on the back side of the first flat surface. As already mentioned, such identifier can be printed on the first flat surface before the first and second parts are joined, or after the first and second parts have been joined.

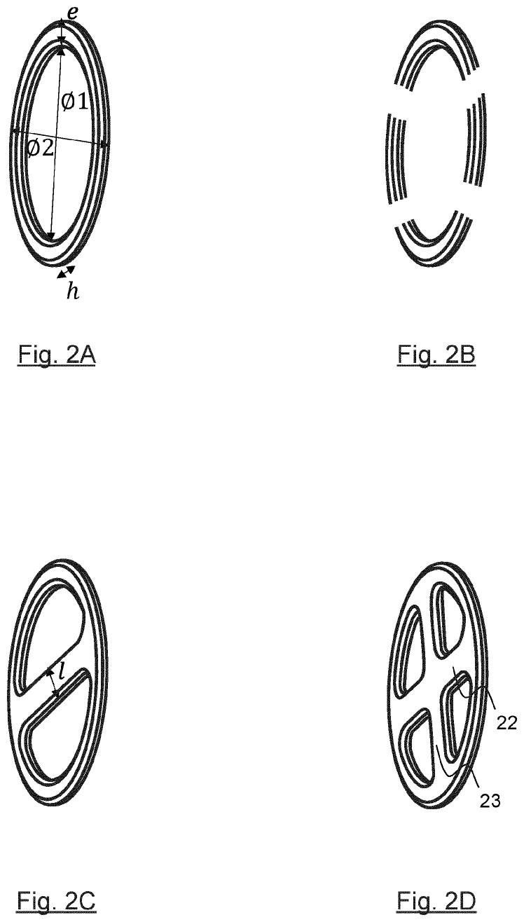

FIGS. 2A to 2D illustrate different examples of circular ring-shape raised portions, that can be possibly be used on the same first part. Similar examples can be given for elliptical ring-shape raised portions.

As illustrated in FIG. 2A, a raised portion can be a continuous ring, i.e. an excess thickness localized between two concentric circles of diameters φ1 and φ2. For example, the inner diameter φ1 of the ring can be comprised between 3.5 mm and 4.5 mm, for example 4 mm, and the outer diameter φ2 can be comprised between 4.5 mm and 5.5 mm, for example 5 mm. The thickness e between the inner diameter φ1 and outer diameter φ2 if for instance comprised between 0.5 mm and 1.5 mm, for example 1 mm. The height h of the ring can be comprised between 0.2 mm and 0.6 mm, for example 0.4 mm.

As illustrated in FIG. 2B, a raised portion can be a discontinuous ring, with for example the dimensions disclosed above. At least one space can be provided in the ring.

As illustrated in FIGS. 2C and 2D, a raised portion can be a continuous or a discontinuous ring, with at least one bridge between two points of the inner circle/ellipse. In the example illustrated in FIG. 2C, one bridge 21 is proposed to connect opposite points of the inner circle/ellipse. The larger of the bridge can be comprised between 0.5 and 1,5 mm, for example 0.8 mm. In the example illustrated in FIG. 2D, two bridges 22 and 23 are proposed to connect opposite points of the inner circle/ellipse. For a same ring, the larger of the bridges can be different.

It can be noted that the size of the ring (inner diameter, outer diameter and/or height), as well as the number of bridges (no bridge, one or more bridges) are not limited to the examples illustrated, and can vary, depending for example on the resistance sought to provisionally join two parts of at least one tag.

In other embodiments, not illustrated, the ring-shape raised portion is not a circular ring-shape raised portion, but an elliptic ring-shape raised portion. In the following, we use the term ring-shape to describe and include both the circular ring-shape raised portions and the elliptic ring-shape raised portions.

According to the disclosure, at least two parts of at least one identification tag can be placed on top of each other, partially overlapping. The raised portion(s) can then be melted in order to join the overlapping parts.

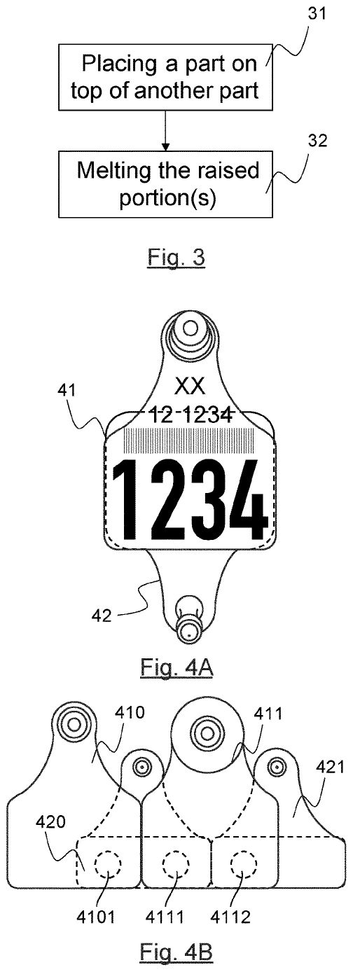

FIG. 3 illustrates exemplary steps of a method for provisionally joining a first part and a second part of at least one animal identification tag, according to the disclosure. The first part can be the male part, resp. the female part, of a two-piece identification tag and the second part can be the female part, resp. the male part, of the same or another two-piece identification tag. In another embodiments, the two parts can be two male parts, two female parts or even one-piece identification tag.

The first part has a first flat surface portion and the second part has a second flat surface portion, at least one of the first or second flat surface portions comprising at least one raised portion having an elliptical ring shape. The first part and the second part do not have necessarily the same shape and/or size.

As illustrated in FIG. 3, the method comprises:
placing (31) the first part and the second part such that the first flat surface portion and the second flat surface portion partly overlap at the location of said at least one raised portion,
melting (32) said at least one raised portion until said first and second parts are joined.

Said steps can be repeated to join several parts.

The raised portion(s) can thus be considered as an energy director, that can be melted, for example by heating said raised portion, in order to join two parts together.

In the first embodiment illustrated in FIG. 4A, called here “head to tail” or “top to tail”, the first part 41 is for example the female part illustrated in FIG. 1A, having at least one raised portion in the bottom area of the first flat surface portion. The second part 42 can be a male part having a second flat surface portion and a second linking portion (comprising the stem ending in a tip). The first part 41 and the second part 42 of the animal identification tag are placed (31) such that the bottom area of the first flat surface portion (comprising at least one raised portion) partly overlaps the second flat surface portion, the first part 41 and the second part 42 being top to tail.

In the second embodiment illustrated in FIG. 4B, called here “side overlapping”, the first part 410 is for example the female part illustrated in FIG. 1B, having at least one raised portion in a side area of the first flat surface portion. The second part 420 can be a male part having a second flat surface portion and a second linking portion (comprising the stem ending in a tip). The first part 410 and the second part 420 of the animal identification tag are placed (31) such that a side area of the first flat surface portion (comprising at least one raised portion) partly overlaps the second flat surface portion.

As illustrated in FIG. 4B, the bottom edge of the first flat surface portion and the bottom edge of the second flat surface portion can be aligned during the placement step. In another embodiment, not illustrated, the top edge of the first linking portion and the top edge of the second linking portion can be aligned during the placement step. According to another embodiment, neither the bottom edges of the flat surface portions, nor the top edges of the linking portions are aligned during the placement step.

If two tags are to be attached on a same animal, the two tags carrying or designed to carry an identifier enabling to identify the same animal can be joined. As an alternative, two or more tags that are not intended to be fixed on the same animal can be joined, in order to form a strip of tags that can be easily handled.

For example, as illustrated in FIG. 4B, the female part 410 and the male part 420 belong to a first two-piece identification tag, and the female part 411 and the male part 421 belong to a second two-piece identification tag.

During the placement step, the four parts are ordered such that (from a rear view of FIG. 4B) the left area of the first flat surface portion of the female part 410 comprising at least one raised portion 4101 overlaps the right area of the second flat surface portion of the male part 420, the right area of the first flat surface portion of the female part 411 comprising at least one raised portion 4111 overlaps the left area of the second flat surface portion of the male part 420, and the left area of the first flat surface portion of the female part 411 comprising at least one raised portion 4112 overlaps the right area of the second flat surface portion of the male part 421.

Once again, those are only illustrative examples, and other arrangements of the first and second parts can be proposed. In addition, even if the specification is focused on the joining of a male and a female part of a two-piece identification tag, such process can be used to join male parts together and/or female parts together, that belong or not to the same identification tag.

Once the various parts have been placed in an overlapping arrangement at the location of the raised portion(s), the raised portion can be melted (32) in order to join the different parts. For example, said melting is performed by welding, such as ultrasonic welding. A sonotrode with a cylindrical tool having a flat surface at its extremity can be used for instance. The sound waves from an ultrasonic welding head can penetrate the raised portion(s) of the first part and melt them. The raised portion(s) will act as energy director(s) and start to fuse with the material of the second part. After cooling, both parts are connected.

It is thus possible to join a pair of male and female parts, and possibly several pairs of male and female parts. As already mentioned, it is also possible to join several male parts together or several female parts together, or even several one-piece identification tags.

Once connected, the parts can be for example transported from the manufacturing center to a farm. A farmer/user can handle such joined parts to apply at least one tag to at least one animal.

FIG. 5 illustrates exemplary steps of a method for loading an animal identification tag on an applicator according to the disclosure.

We consider that the animal identification tag comprises a first part having a first flat surface portion and a second part having a second flat surface portion, the first flat surface portion and the second flat surface portion partly overlapping, the first part and the second part being provisionally joined together through the method disclosed in FIG. 3, for example. The first part can be the male part, resp. the female part, of a two-piece identification tag and the second part can be the female part, resp. the male part, of the two-piece identification tag.

As illustrated in FIG. 5, the method comprises:
loading (51) the second part of the animal identification tag on the applicator, with the first part and the second part joined together,
separating (52) the first part and the second part by a movement of the applicator,
loading (53) the first part of the animal identification tag on the applicator.

For example, the second part which is first loaded (51) on the applicator is the male part of the identification tag. To do so, a pin of the applicator can be inserted into the shaft/stem of the male part. The user can thus hold the applicator with one hand, the strip of at least two parts with his other hand, and insert the pin of the applicator into the shaft/stem of the male part. There is no need for a user to use his two hands to separate the two parts. This is advantageous at least because the user does not have to place the applicator down to separate the tags with two hands.

The user can then hold the applicator with one hand, and pull apart the strip with his other hand to separate (52) the second part/male part from the first part/female part. As said first and second parts can been joined through the melting of at least one raised portion having an elliptical ring shape, the user does not have to pull on a specific direction to detach the two parts.

The first part (53) can then be loaded on the applicator.

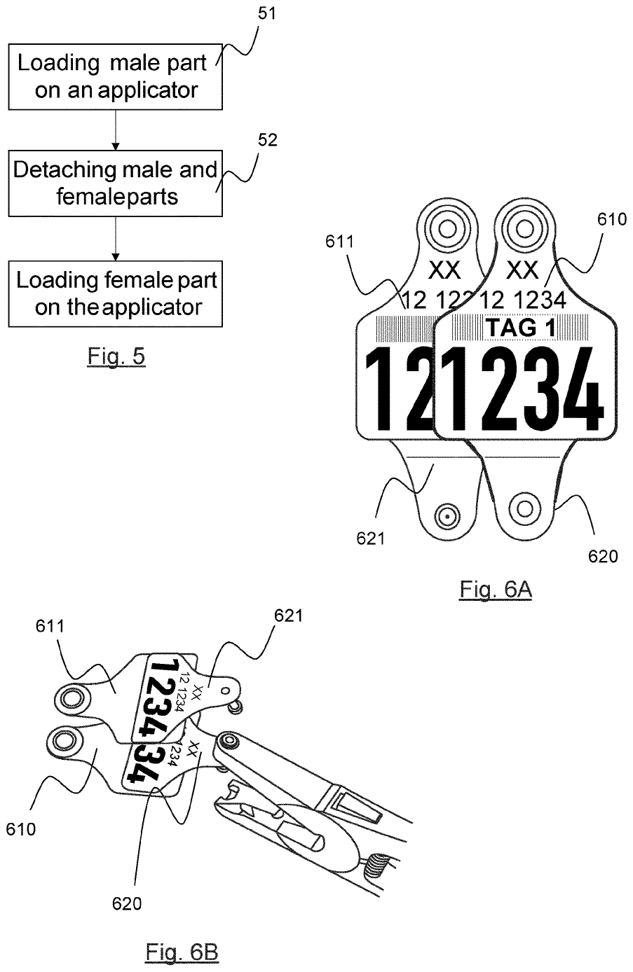

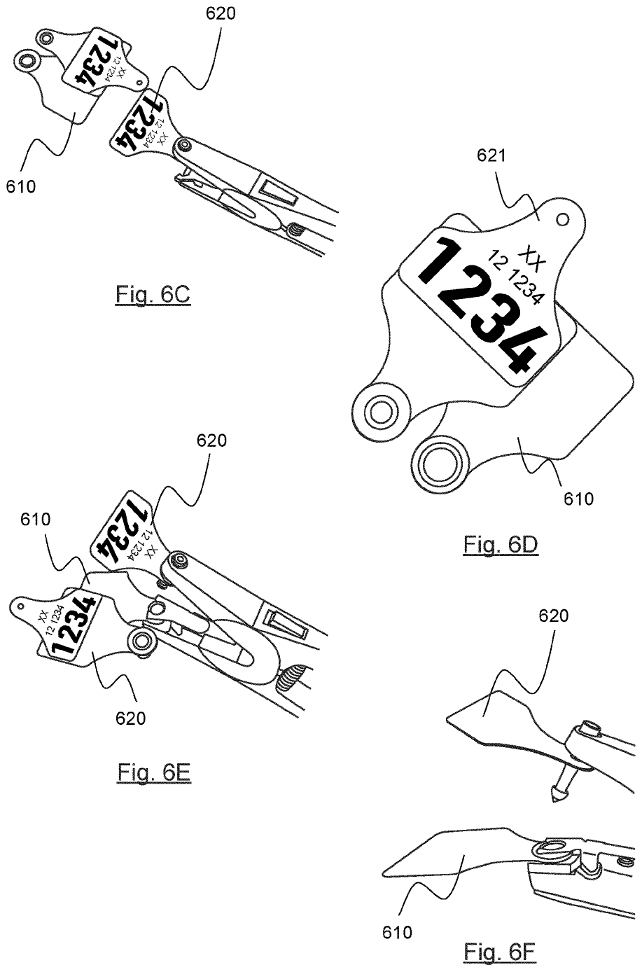

FIGS. 6A to 6F illustrate the method for loading a male part and a female part which have been joined head to tail, according to the first embodiment illustrated in FIG. 4A.

As illustrated in FIG. 6A, we consider for example two identification tags, with the male part 620 and female part 610 of the first tag joined head to tail, and the male part 621 and female part 611 of the second tag joined head to tail, through the melting of at least one raised portion (energy directors) as described above.

The two identification tags can also be joined, for example through the melting of at least one raised portion as described above. In another embodiment, the two identification tags can be provisionally joined using ultrasonic welding without raised portion, using a glue, such as a fugitive glue, a part that tears, an additional packaging, etc.

For example, the two identification tags are joined by ultrasonic welding as well, but without the use of raised portions as described above. A specific tool can be fitted on the ultrasonic head (sonotrode) in order to join the first tag and the second tag. The tool has for example two pins /cylinders at its extremity. When the process to temporarily join the two identification tags is launched, the tool is first engaged into one identification tag, for example through the male part 620 and/or female part 610 of the first tag. As the tool has two pins, two small holes are formed in the male part 620 and/or female part 610. The plastic material extracted from the two holes is then melted, for example by heat, in order to connect the two identification tags together. In this case, the energy director is replaced with the plastic material extraction.

FIG. 6B illustrates the loading of the first tag on the applicator, starting for example with the male part 620 of the first tag.

As illustrated in FIG. 6C, the male part 620 is separated from the female part 610, for example through a translation movement (pulling in a direction opposed to the applicator).

FIG. 6D illustrates the remaining parts after the male part 620 has been separated from the female part 610, i.e. the female part 610 of the first tag, the male part 621 of the second tag and the female part 611 of the second tag.

As illustrated in FIG. 6E, the female part 610 of the first tag can then be loaded on the applicator, for example through an applicator adaptor. The second tag can be separated from the female part 610 of the first tag, for example through a translation movement (pulling in a direction opposed to the applicator, for example).

FIG. 6F illustrates the applicator ready to apply the first tag.

The steps described above can then be repeated to load the second tag on the applicator.

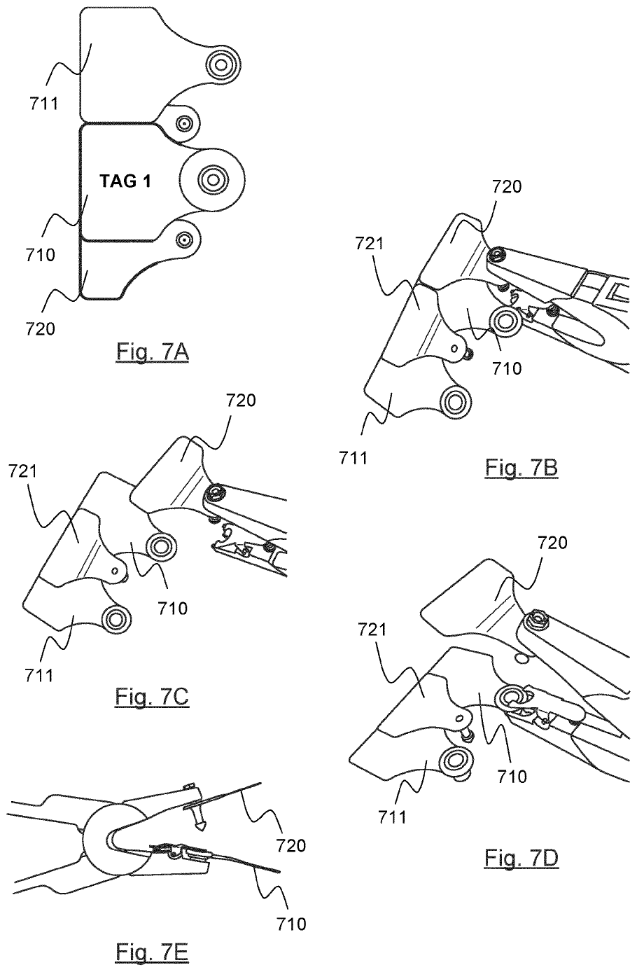

FIGS. 7A to 7E now illustrate the method for loading a male part and a female part which have been joined in side overlapping, according to the second embodiment illustrated in FIG. 4B.

As illustrated in FIG. 7A, we consider for example two identification tags, with the male part 720 and female part 710 of the first tag joined in side overlapping, the male part 721 and female part 711 of the second tag joined in side overlapping. The two tags are also joined as previously described in view of FIG. 4B.

FIG. 7B illustrates the loading of the first tag on the applicator, starting for example with the male part 720 of the first tag.

As illustrated in FIG. 7C, the male part 720 is separated from the female part 710, for example through a translation movement (pulling in a direction opposed to the applicator). The remaining parts after the male part 720 has been separated from the female part 710 are the female part 710 of the first tag, the male part 721 of the second tag and the female part 711 of the second tag.

As illustrated in FIG. 7D, the female part 710 of the first tag can then be loaded on the applicator, for example through an applicator adaptor. The second tag can be separated from the female part 710 of the first tag, for example through a translation movement (pulling in a direction opposed to the applicator).

FIG. 7E illustrates the applicator ready to apply the first tag.

The steps described above can then be repeated to load the second tag on the applicator.

In the different examples, the user thus does not have to use his two hands to separate the male and female parts. Loading of the tag on the applicator is thus facilitated. In addition, as already mentioned, thanks to the use of elliptical ring shape raised portion(s), the separation of the different parts is easy, and there is no need to pull on a specific way to detach them. After peeling of the two parts, there is no main bumps or rough patches that could injury the animal due to the shape and dimension of the raised portion(s).

The user experience, as well as the animal well-being, are thus improved according to at least one embodiment of the disclosure.

1. A first part of an animal identification tag, having a first flat surface portion comprising at least one raised portion,
wherein said at least one raised portion has an elliptical ring shape which is configured to be melted to provisionally join the first flat surface portion to a second flat surface portion of a second part of an animal identification tag.

2. The first part according to claim 1, wherein said at least one raised portion has a discontinuous elliptical ring shape.

3. The first part according to claim 1, wherein said at least one raised portion has an inner diameter comprised between 3.5 mm and 4.5 mm, an outer diameter comprised between 4.5 mm and 5.5 mm, and a thickness between the inner and outer diameters comprised between 0.5mm and 1.5mm.

4. The first part according to claim 1, wherein said at least one raised portion has a height comprised between 0.2 mm and 0.6 mm.

5. The first part according to claim 1, wherein the first flat surface portion comprises two raised portions having each an elliptical ring shape.

6. The first part according to claim 1, wherein the first flat surface portion comprises a top area connected to a first linking portion of the first part, and a bottom area, and wherein said at least one raised portion is located in the bottom area of the first flat surface portion.

7. The first part according to claim 1, wherein the first flat surface portion comprises a left area and a right area both connected to a first linking portion of the first part, and
wherein said at least one raised portion is located in the left area and/or in the right area of the first flat surface portion.

8. The first part according to claim 1, wherein an identifier is printed on a side of the first flat surface portion opposite to the side comprising said at least one raised portion.

9. A method for provisionally joining a first part and a second part of at least one animal identification tag,
the first part having a first flat surface portion and the second part having a second flat surface portion, at least one of the first or second flat surface portions comprising at least one raised portion having an elliptical ring shape,
wherein the method comprises:
placing the first part and the second part such that the first flat surface portion and the second flat surface portion partly overlap at the location of said at least one raised portion,
melting said at least one raised portion until said first and second parts are joined.

10. The method according to claim 9, wherein said melting is performed by ultrasonic welding.

11. The method according to claim 9, wherein:
the first flat surface portion of the first part comprising a top area connected to a first linking portion of the first part, and a bottom area,
said placing places the first part and the second part such that the bottom area of the first flat surface portion partly overlaps the second flat surface portion.

12. The method according to claim 9, wherein:
the first flat surface portion of the first part comprising a left area and a right area both connected to a first linking portion of the first part,
said placing places the first part and the second part such that the second flat surface portion partly overlaps the left area and/or the right area of the first flat surface portion.

13. The method according to claim 12, wherein said placing places a first two-piece identification tag and a second two-piece identification tag, such that:
the left area of the first flat surface portion of the first identification tag overlaps the right area of the second flat surface portion of the first identification tag,
the right area of the first flat surface portion of the first identification tag overlaps the left area of the second flat surface portion of the second identification tag, and
the left area of the first flat surface portion of the second identification tag overlaps the right area of the second flat surface portion of the second identification tag.

14. A method for loading an animal identification tag on an applicator, the animal identification tag comprising a first part having a first flat surface portion and a second part having a second flat surface portion, the first flat surface portion and the second flat surface portion partly overlapping,
wherein, the first flat surface portion and the second flat surface portion being provisionally joined by melting at least one raised portion of the first and/or the second flat surface portion, said at least one raised portion having an elliptical ring shape,
the method comprises:
loading the second part of the animal identification tag on the applicator, with the first part and the second part joined together,
separating the first part and the second part by a movement of the applicator,
loading the first part of the animal identification tag on the applicator.

15. The method of claim 14, wherein separating the first part and the second part comprises pulling the applicator and pulling the second part in opposite directions.
